(19) United States
(12) Patent Application Publication
(10) Pub. No.: US 2012/0297038 A1
(43) Pub. Date: Nov. 22, 2012

(54) Recommendations for Social Network Based on Low-Rank Matrix Recovery

(75) Inventors: Tao Mei, Beijing (CN); Xian-Sheng Hua, Beijing (CN); Shipeng Li, Palo Alto, CA (US); Jinfeng Zhuang, Singapore (CN)

(73) Assignee: Microsoft Corporation, Redmond, WA (US)

(21) Appl. No.: 13/108,843

(22) Filed: May 16, 2011

(51) Int. Cl. G06F 15/173; G06F 17/30

(52) U.S. Cl. 709/223; 707/737; 707/E17.019

(57) ABSTRACT

Techniques describe analyzing users and groups of a social network to identify user interests and providing recommendations for a user based on the user's identified interests. A content-awareness application obtains a collection of images and tags associated with the images belonging to members in the social network. The content-awareness application decomposes the members into a representative matrix to identify users and groups in order to calculate a similarity matrix between the users and their images based on a visual content of the images and a textual content of the tags. The content-awareness application further constructs a graph Laplacian over the users and the groups to align with the representative matrix based at least in part on the similarity matrix and further provides recommendations of groups for a user to join in the social network based at least in part on the graph Laplacian identifying the user's interests.

### BACKGROUND

The increasing popularity of social networking creates hundreds of different types of websites for users and attracts a surge of attention for social media mining research. Social networking offers a variety of websites building on social relationships among people sharing common interests, activities, events, and the like. Some social networking websites may be interest related, such as photography, movies, books, travels, languages, sporting activities, and the like. The social networking websites include a community of individual users each having a profile containing information about that user. Some users may also upload photographs of themselves to their profiles. Typically, the social networking websites allow the users to create or to join self-organized interest groups or to add other users into their contact lists.

However, users tend to create groups that may be subjective causing the observed group-user and user-user relationship information to be noisy and incomplete in nature. In addition, due to the large number of groups available on the social networking websites, the users may join groups, which do not actually match their interests. The users may not browse through each of the groups or the tags associated with the groups prior to joining those groups. Also, the users may not browse through other users' profiles before sending invitations to join their contact lists. Thus, it becomes difficult to identify relevant groups to join or to identify people to add to contact lists.

### SUMMARY

This disclosure describes analyzing users and groups of a social network to identify user interests and providing recommendations for a user based on the user's identified interests. In an implementation, this process occurs when a content-awareness application obtains a collection of images and tags associated with the images belonging to members in the social network. The content-awareness application decomposes the members into a representative matrix to identify users and groups in order to calculate a similarity matrix between the users and their images based on a visual content of the images and a textual content of the tags. The content-awareness application further constructs a graph Laplacian over the users and the groups to align with the representative matrix based at least in part on the similarity matrix and further provides recommendations of groups for a user to join in the social network based at least in part on the graph Laplacian identifying the user's interests.

In another implementation, a low-rank recovery algorithm helps refine recommendations for groups by enforcing global content consistency of images and tags. The enforcement of global content consistency helps remove distortions in the data. The low-rank recovery algorithm aligns a representative matrix with a graph Laplacian to rectify group assignments. The low-rank recovery algorithm solves for a representative group matrix and an error matrix using an accelerated proximal gradient method.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment to support an architecture for analyzing users and groups in a social network to provide recommendations based on the analysis.

FIG. 2 illustrates example high-level functions for decomposing membership of the social network, computing a similarity matrix among the users and their images, constructing graph Laplacian, optimizing the graph Laplacian based on an accelerated proximal gradient, and providing recommendations.

FIG. 3 illustrates example diagrams of decomposing a membership group matrix in the social network to a representative group matrix along with an error matrix.

FIG. 4 illustrates example diagrams of the representative group matrix identifying similarities among users and themes among the groups based on row and column views.

FIG. 5 illustrates an example process of computing a similarity matrix from the representative group matrix based on similarities between the users and their images based on a visual content and tags based on a textual content.

FIG. 6 illustrates an example process of constructing graph Laplacian over the users.

FIG. 7 illustrates an example diagram for providing recommendations to the user based on the analysis of the user's interests and activities in the social network.

FIG. 8 is a block diagram showing an example networking server usable with the environment of FIG. 1.

### DETAILED DESCRIPTION

### Overview

This disclosure describes analyzing users and groups in a social network or in an online community and providing recommendations, suggestions, and/or applications based on the analysis. A content-awareness application may be implemented as a part of the social network or the online community to perform the analysis and to provide the recommendations, the suggestions, and/or the applications.

In an example, a content-awareness application provides recommendations for a user to join groups that currently exist in an online community. The user receives the recommendations for various groups that are relevant to the user based on interests and/or activities of the user. For instance, the user belongs to the online community focusing on a hobby, such as photography. The user shares with other users by uploading their vacation photographs of London on the online community. The content-awareness application performs an analysis of the photographs of London to determine the interests and/or the activities of the user, and to identify any annotations or tags provided for the photographs. Based on the analysis of the photographs, the annotations, and/or the tags, the content-awareness application provides the recommendations in a rank order list of groups based at least in part on the user's interests and/or activities. For example, the rank order list may include groups based on the location in the photograph. Thus, the user may participate with other users that share a common interest and activities of London based on their uploaded photographs.

In another example, a content-awareness application may provide suggestions of a list of potential contacts for a user in a social network. The user receives the suggestions of various members to send invitations to join the user's contact list based on the user's and the potential contacts' activities and interests based on their images, tags, and groups. For instance, the user's interest may be directed towards running marathons in New York City (NYC). The user uploads their photographs taken at the marathons in NYC on the social network. The content-awareness application performs an analysis of photographs along with any annotations and tags associated with the photographs to determine the user's activities, interests, and groups relevant to the potential contacts' activities, interests, and groups. Based on the analysis, the content-awareness application provides a rank list in a descending order of potential contacts sharing a common interest of running marathons in NYC. Thus, the user may want to connect with the potential contacts who share common interests, about training, clothing, running shoes, places to stay or eat in NYC, setting up a meeting, and the like.

While aspects of described techniques can be implemented in any number of different computing systems, environments, and/or configurations, implementations are described in the context of the following example computing environment.

### Illustrative Environment

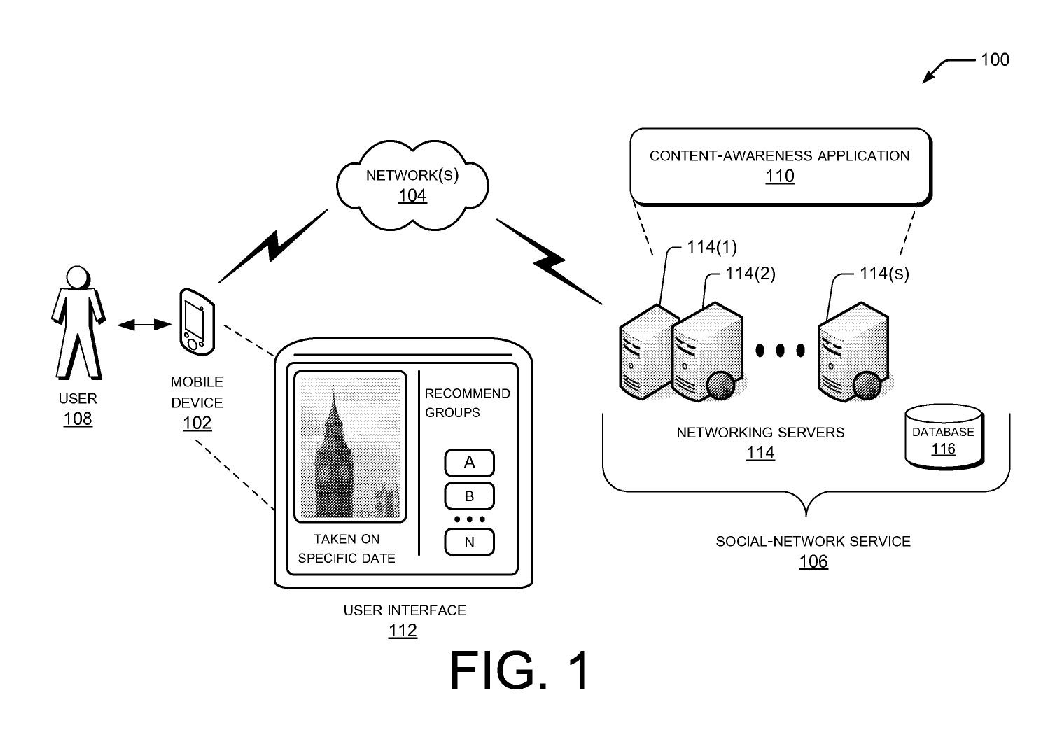

FIG. 1 illustrates an example architectural environment 100, usable to provide access to the social network and to provide recommendations of groups, suggestions of potential contacts, advertisements, services, list of organizations, and the like based on the analysis of group-user relationship and user-user relationship. The environment 100 includes an example mobile device 102, which is illustrated as a smart phone. The mobile device 102 is configured to connect via one or more networks 104 to access a social network service 106 for a user 108. The mobile device 102 may take a variety of forms, including, but not limited to, a portable handheld computing device (e.g., a personal digital assistant, a smart phone, a cellular phone), a personal navigation device, a laptop computer, a desktop computer, a portable media player, or any other device capable of connecting to the one or more networks 104 to access the social network service 106 for the user 108.

The one or more networks 104 represent any type of communications networks, including wire-based networks (e.g., public switched telephone, cable, and data networks) and wireless networks (e.g., cellular, satellite, WiFi, and Bluetooth).

The social-network service 106 represents an online service that may be operated as part of any number of service providers, such as a web service, a social network, a website, an online community, a search engine, a map service, or the like. Also, the social-network service 106 may include additional modules or may work in conjunction with modules to perform the operations discussed below. In an implementation, the social-network service 106 may be implemented at least in part by a content-awareness application 110 executed by servers, or by a content-awareness application stored in memory of the mobile device 102.

In the illustrated example, the mobile device 102 may include a user interface (UI) 112 that is presented on a display of the mobile device 102. For instance, the UI 112 facilitates access to the social-network service 106 to join as a member of the community in the social network. In this example, the user 108 may access the social-network service 106 and then the content-awareness application 110 to upload vacation photographs from London. The UI 112 illustrates a photograph of “Big Ben and Westminster Abbey as viewed from the London Eye” taken on a specific date. The UI 112 may also display the recommendations, suggestions, and/or applications provided to the user 108. For brevity, the term recommendations may be used to describe recommendations, suggestions, and/or applications to the user 108. The UI 112 may display a ranking of the group recommendations in a descending order, shown as A, B, . . . N. For example, the rank order list may include groups of locations based on the photographs of Big Ben and Westminster Abbey, such as Information about London (shown as A), Vacationing in London (shown as B), Living in London (shown as N), and the like. Thus, the user 108 may participate with other users that share a common interest and activities of photographing London based on the analysis of their photographs, annotations, and/or tags.

In the illustrated example, the social-network service 106 and the content-awareness application 110 are hosted on one or more servers, such as networking servers 114(1), 114(2), . . . , 114(S), accessible via the one or more networks 104. The networking servers 114(1)-(S) may be configured as plural independent servers, or as a collection of servers that are configured to perform larger scale functions accessible by the one or more networks 104. The networking servers 114 may be administered or hosted by a network service provider. The social-network service 106 may be implemented by the networking server 114 and the content-awareness application 110 to and from the mobile device 102.

The environment 100 includes a database 116, which may be stored on a separate server or with the representative set of networking servers 114 that is accessible via the one or more networks 104. The database 116 may store the images, the annotations and the tags associated with the images, user information, interest group information, group-user and user-user relationship information, and the like. The content-awareness application 110 may then retrieve the information from the database 116 to perform the analysis, as the database 116 may be updated on a predetermined time interval.

In an example, the content-awareness application 110 may provide two or more recommendations in a social network website. The social network website may include photography as a focus with annotations in the photographs submitted by the user 108. For instance, the content-awareness application 110 may provide recommendations of a list of groups and suggestions of a list of potential contacts to be added to the user's contact list based on sharing common interests and/or activities through discovery of the photographs with the annotations or the tags associated with the photographs.

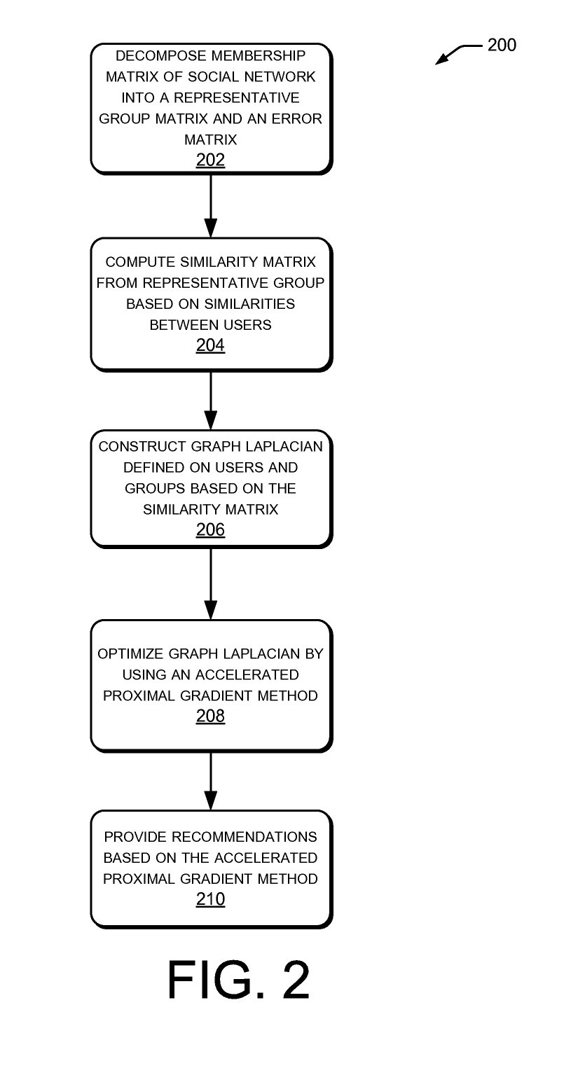

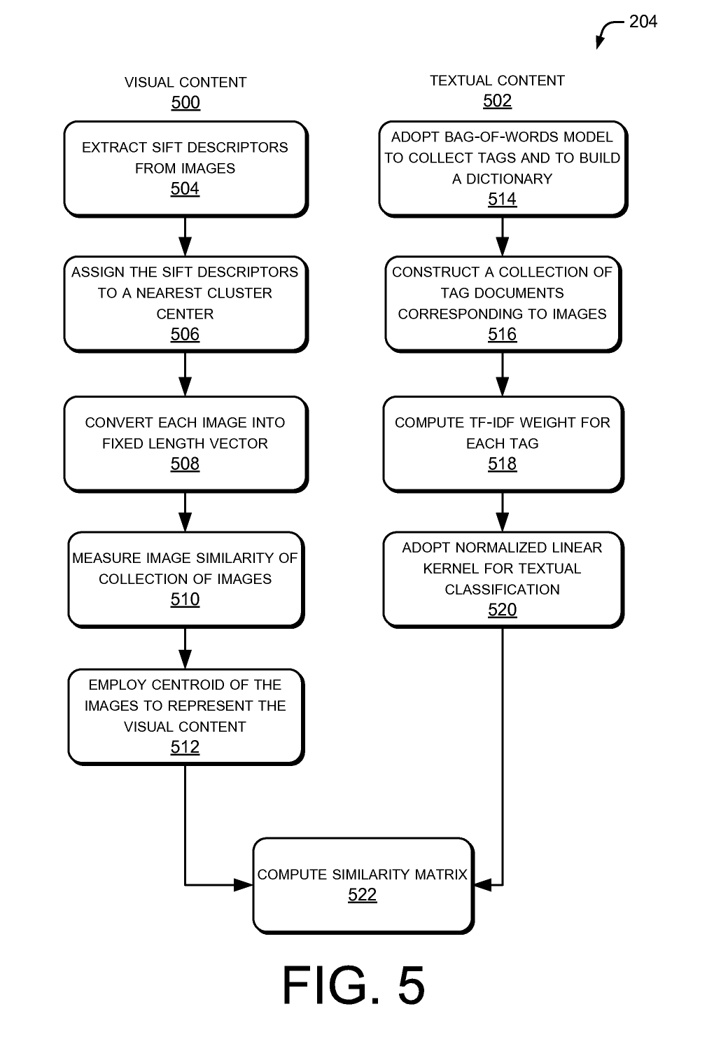

FIGS. 2 and 5 illustrate flowcharts showing example processes. The processes are illustrated as a collection of blocks in logical flowcharts, which represent a sequence of operations that can be implemented in hardware, software, or a combination. For discussion purposes, the processes are described with reference to the computing environment 100 shown in FIG. 1. However, the processes may be performed using different environments and devices. Moreover, the environments and devices described herein may be used to perform different processes.

For ease of understanding, the methods are delineated as separate steps represented as independent blocks in the figures. However, these separately delineated steps should not be construed as necessarily order dependent in their performance. The order in which the process is described is not intended to be construed as a limitation, and any number of the described process blocks maybe be combined in any order to implement the method, or an alternate method. Moreover, it is also possible for one or more of the provided steps to be omitted.

### High-Level Functions Performed by the Content-Awareness Application

FIG. 2 illustrates a flowchart showing an example process 200 of high-level functions performed by the content-awareness application 110. The process 200 may be divided into five phases, an initial phase 202 to decompose a membership matrix of the social network into a representative group matrix and an error matrix, a second phase 204 to compute a similarity matrix from a representative group based on similarities between the users, a third phase 206 to construct graph Laplacian defined on users and groups based on the similarity matrix, a fourth phase 208 to optimize graph Laplacian by using an accelerated proximal gradient method, and a fifth phase 210 to provide recommendations based on the accelerated proximal gradient method. All of the phases may be used in the environment of FIG. 1, may be performed separately or in combination, and without any particular order.

The first phase 202 decomposes the membership matrix of the social network into the representative group matrix of users and groups and the error matrix of noise. The membership information tends to be noisy and incomplete as users may create groups without any restrictions. Thus, a representative group presents a “true” group of users. The representative group matrix may be considered to be a low-rank matrix (e.g., such as a rank of one), indicative that the groups in the social network tends to be semantically related in terms of content.

The second phase 204 computes the similarity matrix from the representative group based on similarities between the users. Using the example of the photography-focused social network, the computation of the similarity matrix utilizes components that include a collection of images in a visual content and the annotations or the tags associated with the images in a textual content.

The third phase 206 constructs the graph Laplacian defined on users and groups based on the similarity matrix. The content-awareness application 110 adopts a bag-of-words model for the visual representation and extracts descriptors from images and collects the annotations and/or the tags to build a dictionary for the textual representation.

The fourth phase 208 optimizes the graph Laplacian by using an accelerated proximal gradient method. The accelerated proximal gradient method applies a low-rank matrix recovery algorithm that solves iteratively for the representative group matrix and for the error matrix. The low-rank matrix recovery algorithm refines the groups, potential contacts, and the like.

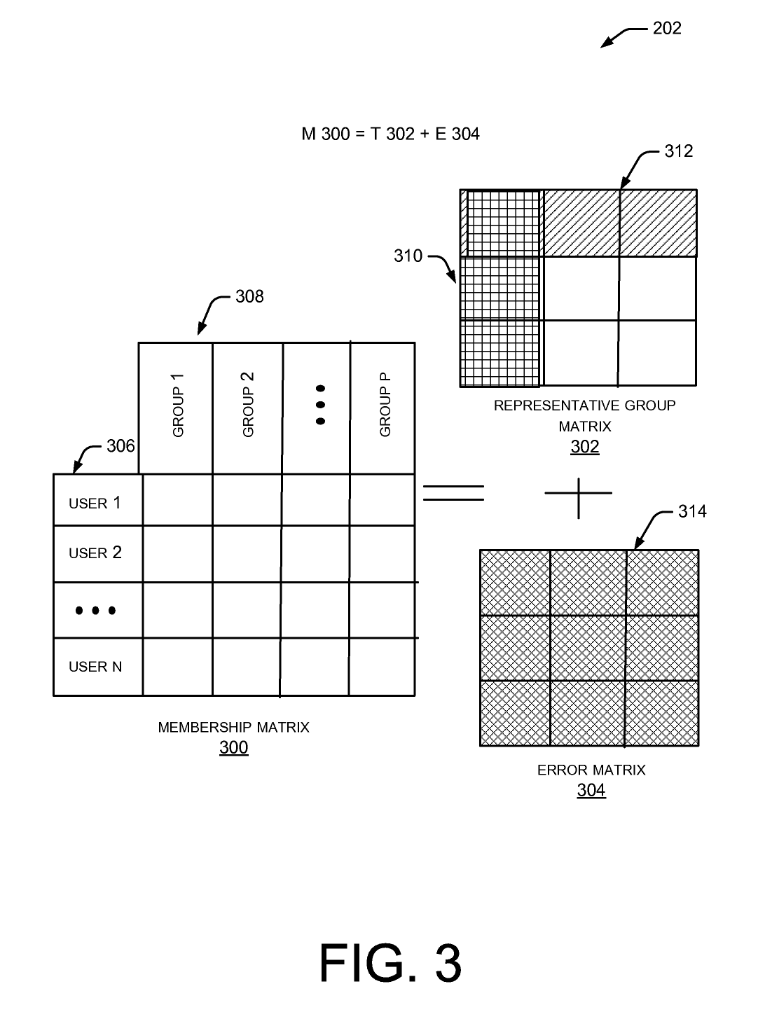

The fifth phase 210 provides the recommendations based on the outcome of the accelerated proximal gradient method. Based on the low-rank recovery algorithm used for the optimization of the graph Laplacian, the content-awareness application 110 provides recommendations for groups, provides suggestions for potential contacts, and the like. Details of the phases are discussed with reference to FIGS. 3 to 8 below.

### Decomposing the Members Group Matrix

FIG. 3 illustrates the example phase 202 of the content-awareness application 110 decomposing the membership matrix 300 of the social network into the representative group matrix 302 and the error matrix 304 (discussed at a high level above). In an implementation, the user 108 accesses the social-network service 106 to join as a member in a photography-focused social network. The content-awareness application 110 may receive or collect images (i.e., photographs), annotations, or tags associated with the images, and/or information from users who have given permission for their data to be collected and analyzed as part of being a member of the social network. In another implementation, the data may include geo-location of each image, comments shared between members, comments from members, contact list, and the like.

A diagram of the membership matrix 300 illustrates observed users 306 in a first column ranging from user 1, user 2, . . . user N and observed groups 308 in a first row ranging from group 1, group 2, . . . group P. Recall the membership matrix 300 includes noise and is incomplete due to the manner in which users (i.e., members in the social network) may create groups without any type of restrictions. Furthermore, due to the large number of groups available on the social network, the users may browse partially through the list of groups and randomly join the groups. Unfortunately, the users may join the groups that are not relevant towards their interests and/or activities and the users do not tend to browse through the entire list of groups. Thus, the groups that may be more relevant towards the users' interests and activities tend to be ignored and not explored for additional information about the groups.

A diagram of the representative group matrix 302 illustrates a first column shown with small block pattern 310 and a first row shown with angled lines 312. The representative group matrix 302 may be considered to be the “true” group members recovered from the membership matrix 300. Recall that the representative group matrix 302 may be very low rank, as many popular groups in the social network tend to be semantically related in terms of shared content. For instance, the user 108 may search “Beijing” on the social network with the search results returning a list of groups of “Beijing Photo Community,” “Beijing,” “Walking in Beijing,” and the like. These groups tend to overlap in part for their common image content. Furthermore, these groups may not have any essential differences in the themes of their groups.

A diagram of the error matrix 304 illustrates columns and rows shown with crisscross lines 314. The error matrix 304 tends to be an unknown sparse matrix of random noise. This diagram is merely an example of a decomposition of the membership matrix that may occur, the membership may be decomposed in any manner suitable for extracting a true group from a membership.

The content-awareness application 110 models this relationship between the observed membership matrix 300 and the representative group matrix 302 using the following equation:

M=T+E

where M represents the membership matrix 300 ε [symbol] ^{N}^{ᵤ}^{×N}^{_{g}}, as a collection of groups the user belongs to, [symbol] ᵤ represents {1, . . . , u}, a set of integers up to u, Nᵤ represents | [symbol] ᵤ|, the cardinality of [symbol] ᵤ, and g represents an interest group. M may represent the group-user relationship by M ε{0, 1}^{N}^{ᵤ}^{×N}^{_{g}}, where the (i, j)-th entry indicates whether uᵢ belongs to gⱼ. Similarly, the user-user contact relationship may be represented by a matrix, N ε{0, 1}^{N}^{ᵤ}^{×N}^{ᵤ}. T represents the “true” representative group matrix 302 ε [symbol] ^{N}^{ᵤ}^{×N}^{_{g}}, and E represents the error matrix 304 υ [symbol] ^{N}^{ᵤ}^{×N}^{_{g}} as sparse random error.

This may be further refined by formulating the equation as an optimization problem of low-rank matrix recovery from the noise and the incomplete observed data M with the following equation:

min_{T,E}rank(T)+∥E∥₀,s.t.M=T+E

where min is for minimum of T, E and s.t. is such that, |*|₀ represents the zero-norm which counts a number of non-zero entities of a matrix. The content-awareness application 110 minimizes both the rank of the representative group matrix 302 and the sparsity of the error matrix 304.

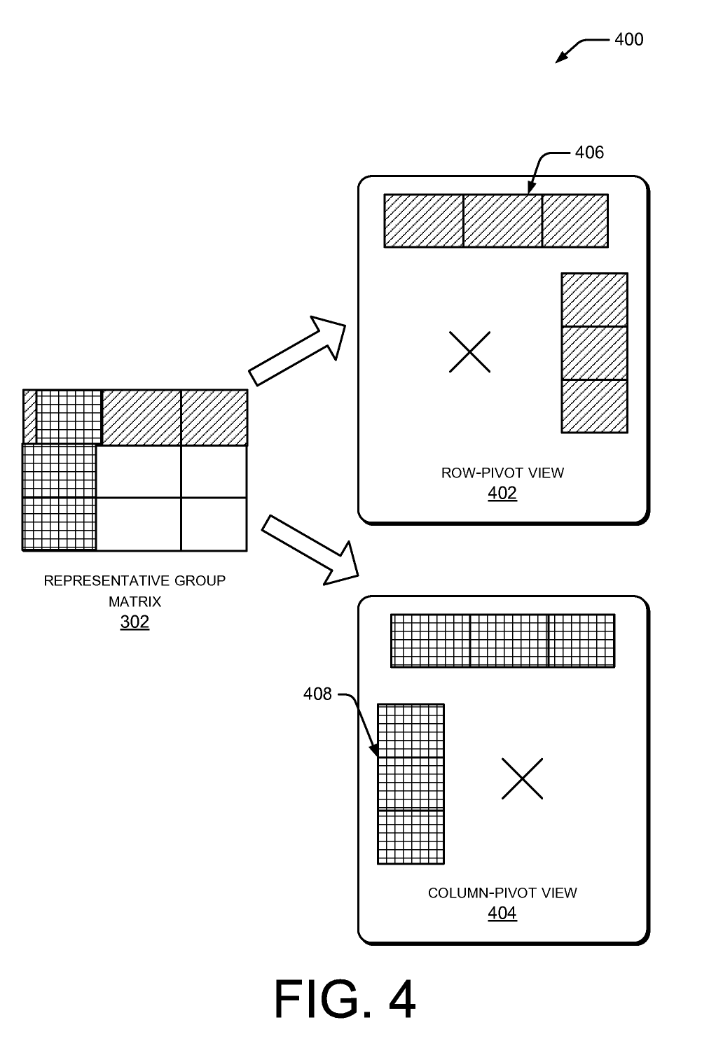

FIG. 4 illustrates example diagrams 400 of the representative group matrix 302 by identifying similarities between users and themes among the groups based on row and column views. The representative group matrix 302 should reflect a global content consistency with respect to the rich information available in the groups and the users. For instance, two users who have uploaded similar images tend to share similar groups.

A diagram of the similarity under a row-pivot view 402 illustrates the i-th row 406 of the representative group matrix 302. The i-th row 406 provides a high-level abstract of the user 108 represented as uᵢ, (i.e., the group assignment of uᵢ reflects a theme or an interest of uᵢ). Thus, the similarity between the users induced by the representative group matrix 302 may be consistent with the similarity computed from the uploaded images. A detailed discussion of the similarity between users follows in Computing a Similarity Matrix.

A diagram of the similarity under column-pivot view 404 illustrates the j-th column 408 of the representative group matrix 302. The j-th column 408 represents a list of members belonging to an interest group gⱼ which may express the theme of group gⱼ. The content-awareness application 110 constructs a Laplacian matrix based on the similarity measure over the groups. The similarity induced from the columns of the representative group matrix 302 may be aligned to the Laplacian over groups as much as possible.

### Computing a Similarity Matrix

FIG. 5 illustrates an example process 204 of computing a similarity matrix from the representative group based on similarities between the users (discussed at a high level above). The similarity matrix illustrates a matrix of scores expressing similarity between two data points, such as two users.

Each image may be represented by a two-view representation with a visual image represented as xᵢ and its associated tags represented as tᵢ. The content-awareness application 110 calculates a similarity matrix between the users and their images based on a collection of images in the visual content 500 and the annotations or the tags associated with the images in the textual content 502.

In the visual content 500, the content-awareness application 110 extracts scale-invariant feature transform (SIFT) descriptors from the images 504. For any image, the SIFT descriptors identify objects in the images to provide a feature description of an object. As part of this process, the content-awareness application 110 adopts a bag-of-words model for representing the visual features.

The content-awareness application 110 assigns the SIFT descriptors to a nearest cluster center 506. The content-awareness application 110 first splits the SIFT descriptors into dₓ groups by using a k-mean clustering process. Based on an image, the content-awareness application 110 assigns each SIFT descriptors to a nearest cluster center.

The content-awareness application 110 converts each image into a fixed length vector 508. The fixed length vector may be represented by xε [symbol] ^{d}^{ₓ}, where dₓ represents a size of a visual dictionary. The i-th component of the vector counts the number of SIFT features assigned to cluster i.

The content-awareness application 110 measures an image similarity of the collection of images 510. The s(xᵢ, xⱼ) image similarity on the visual content X between two images (xᵢ, xⱼ) occurs by using a Gaussian kernel:

$$s ( {x}_{i} , {x}_{j} ) = {e}^{- {‖ {x}_{i} - {x}_{j} ‖}^{2} / {σ}^{2}}$$

where σ represents a kernel parameter.

Next, the content-awareness application 110 employs centroids of the images to represent the visual content 512. A centroid may be referred to as an intersection of the straight lines that divide the image into two parts. The following equation applies for a specific user:

$$\overline{u} = {\sum }_{{x}_{i} ∈ u} {x}_{i} / \vert u \vert$$

where |u| represents a number of photographs belonging to user u.

Once the visual contents may be represented by the centroid of the images, the content-awareness application 110 computes the similarity between users in the visual content. The following equation calculates the similarity between two users based on the visual content:

$${k}^{x} ( u , {u}^{′} ) := {e}^{- {‖ \overline{u} - \overline{{u}^{′}} ‖}^{2} / {σ}^{2}} .$$

In the textual content 502, the content-awareness application 110 adopts the bag-of-words model to collect tags and to build a dictionary 514. The dictionary serves as a reference for the words used in the tags to annotate the images.

Next, the content-awareness application 110 constructs a collection of tag documents corresponding to the images 516. The user 108 may annotate each of the images with a set of tags when uploading the images. The content-awareness application 110 collects all of the tags to construct a single document.

The content-awareness application 110 computes a term frequency-inverse document frequency (tf-idf) weight for each tag 518. The content-awareness application 110 normalizes the counts by tf-idf to evaluate a value of a word to the image in the collection of tags. The word may increase in proportion to a number of times the word appears in the image, while the frequency of the word in the collection offsets the increase. For example, the tf identifies the number of times the word appears in the document and the idf represents a vector to measure a general importance of the word.

Furthermore, the content-awareness application 110 adopts a normalized linear kernel for textual classification 520. The following equation calculates the similarity between two users in the textual content:

$${k}^{t} ( u , {u}^{′} ) = \frac{{\sum }_{i = 1}^{{d}_{t}} {t}_{i} {t}_{i}^{′}}{\sqrt{{\sum }_{i = 1}^{{d}_{t}} {t}_{i}^{2}} \sqrt{{\sum }_{i = 1}^{{d}_{t}} {t}_{i}^{′ 2}}}$$

where the textual content may be expressed as a fixed length vector t ε [symbol] ^{d}^{ₜ} and dₜ represents a size of a tag vocabulary.

Once the kernel functions for the visual content and the textual content have been computed, the content-awareness application 110 computes the similarity matrix between two users 522. The equation to compute the similarity matrix applies the two equations k^{x} (u, u′) and k^{t} (u, u′) from above:

k(u,u′)=αk^{x}(u,u′)+(1−α)k^{t}(u,u′).

The content-awareness application 110 employs the above equation to find a n-nearest neighbor for each user to truncate S: S: sᵢⱼk(uᵢ, uⱼ) if uᵢ is among u′ⱼ n nearest neighbors, or vice versa.

### Constructing and Optimizing Graph Laplacian

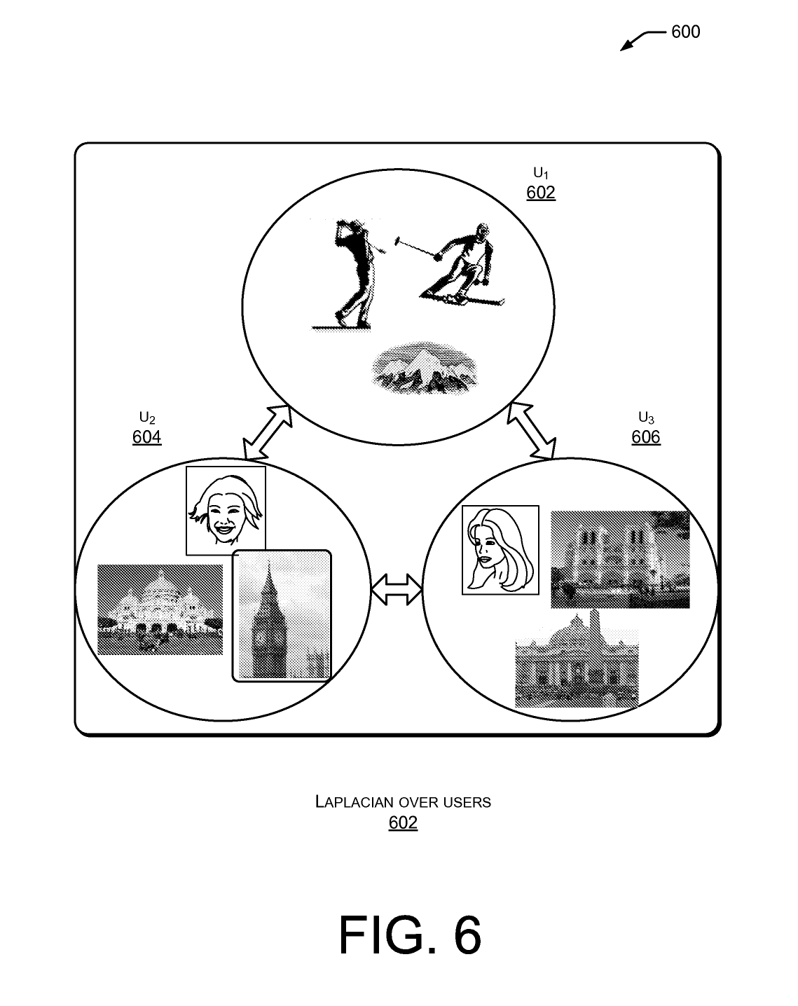

FIG. 6 illustrates an example diagram 600 for the phase 206 of constructing graph Laplacian defined on users based on the similarity matrix (discussed at high functions above).

The content-awareness application 110 uses the similarity matrix computed above to build the graph Laplacian. The equation to build the graph Laplacian includes:

L=I−D^{-1/2}SD^{-1/2}

where D represents a diagonal matrix of D=diag(d₁, d₂, . . . , dₙ), S represents the similarity matrix, and I represents an identity matrix (i.e., elements at the diagonal positions are 1, and 0 otherwise).
This encodes a local geometry of group assignments of the users and of the users based on graph Laplacian. FIG. 6 shows the graph Laplacian over the users: u₁ at 602, u₂ at 604, and u₃ at 606. User 1 at 602 has uploaded images of golfing, skiing, and mountains, user 2 at 604 has uploaded images of herself, Big Ben, and a landmark, Basilica of Sacre-Coeur located in Paris, France and user 3 at 606 has uploaded images of herself, Westminster Abbey, a Gothic church in Westminster, London, England, and the landmark, Basilica of Sacre-Coeur. As a result, the content-awareness application 110 aligns the graph Laplacian to the visual content and to the textual content. While an example is shown for the users, the above diagrams may be used to illustrate graph Laplacian over the groups.

A low-rank recovery algorithm helps refine recommendations for groups by enforcing global content consistency of images and tags. The enforcement of global content consistency helps remove distortions in the data. The content-awareness application 110 minimizes any distortion by using the following equation:

$$\frac{1}{2} {\sum }_{i , j ∈ {ℕ}_{u}} {S}_{ij} {‖ \frac{{T}_{i}}{\sqrt{{d}_{i}}} - \frac{{T}_{j}}{\sqrt{{d}_{j}}} ‖}_{2}^{2} = tr ( {T}^{T} LT )$$

where Sᵢⱼ represents the similarity of two users computed from their uploaded contents, [symbol] Sᵢⱼ represents normalization, Tᵢ represents the i-th row of T, L represents the normalized graph Laplacian, and dᵢ represents a size of a tag vocabulary. The normalized graph Laplacian may be defined as:

L=I−D^{-1/2}SD^{-1/2}

The content-awareness application 110 further optimizes the graph Laplacian by using an accelerated proximal gradient as discussed in the phase 208 of the high-level function. After the graph Laplacian encodes the local geometry of the data, the content-awareness application 110 applies the following equation to define the graph Laplacian on the users and the groups:

min_{T,E}∥T∥_{*}+γ₁∥E∥₁+γ₂(trT^{T}L^{u}T+trTL^{g}T^{T})

s.t.M=T+E,Tε [symbol] ^{N}^{ᵤ}^{×N}^{_{g}},Eε [symbol] ^{N}^{ᵤ}^{×N}^{_{g}}

where L^{u} represents graph Laplacian defined over user, L^{g} represents Laplacian defined over the interest group. The L^{u} represents the group assignment of the uᵢ reflecting the group assignment of uᵢ. The L^{g} represents the list of members of group gⱼ, which may express the theme of group gⱼ to some extent based on some similarity measure over the groups. In addition, the similarity measure from columns of T may be aligned to the Laplacian over the groups as much as possible.

The content-awareness application 110 illustrates the optimization problem with the following equation:

min_{T,E}∥T∥_{*}+∥E∥₁,s.t.M=T+E

where ∥T∥_{*} represents the nuclear norm (i.e., a sum of it singular values) may be adopted to approximate the rank, and l₁₋ₙₒᵣₘ∥E∥₁ may be used to approximate an zero-norm ∥E∥₀. The content-awareness application 110 uses a low-rank recovery algorithm to solve the above equations above by converting the optimization into a non-constrained optimization task to be solved by applying the accelerated proximal gradient technique.

Initially, the content-awareness application 110 considers an unconstrained convex problem by evaluating the following equation:

[symbol]

(x):=μg(x)+f(x)

where [symbol] represents a real Hilbert space endowed with an inner product [symbol] . , . [symbol] , J(x) represents an objective function in general and a corresponding norm ∥•∥. When f(x) is a Lipschitz continuous ∥∇f(x₁−∇f(x₂))∥≦L_{f∥x}_{₁}₋ₓ_{₂}_{∥} with a Lipschitz constant L_{f}, a proximal gradient algorithm minimizes a series of approximations of J, chosen in the form of the following equation:

$$\tilde{J} ( x , y ) := f ( y ) + 〈 ∇ f ( y ) , x - y 〉 + \frac{{L}_{f}}{2} {‖ x - y ‖}^{2} + µ M ( x ) .$$

Next, the content-awareness application 110 solves for the above equation iteratively by using:

xₜ₊₁=arg minₓ\tilde{J}(x,yₜ)

where

$${y}_{t} = {x}_{t} + \frac{{b}_{t - 1} - 1}{{b}_{t}} ( {x}_{t} - {x}_{t - 1} )$$

for sequence {bₜ} satisfying bₜ₊₁²−bₜ≦bₜ². This iterative algorithm achieves the convergence rate O(t⁻²).

In addition, the content-awareness application 110 applies the above technique just described to the following equation

min_{T,E}∥T∥_{*}+γ₁∥E∥₁+γ₂(trT^{T}L^{u}T+trTL^{g}T^{T})

s.t.M=T+E,Tε [symbol] ^{N}^{ᵤ}^{×N}^{_{g}},Eε [symbol] ^{N}^{ᵤ}^{×N}^{_{g}},

to get:

$$g ( x ) = μ {‖ T ‖}_{*} + μ {γ}_{1} {‖ E ‖}_{1} , \\ f ( x ) = \frac{μ {γ}_{2}}{2} \{ tr {T}^{T} {L}^{u} T + tr {TL}^{g} {T}^{T} \} + \frac{1}{2} {‖ M - T - E ‖}_{F}^{2}$$

where the term 1/2∥M−T−E∥_{F}² may be added to convert the original objective into an unconstrained optimization problem,

$$x = ( \begin{matrix}T \\ E\end{matrix} ) , Y = ( \begin{matrix}{Y}^{T} \\ {Y}^{E}\end{matrix} ) .$$

Y represents intermediate variables as shown in an algorithm in paragraph [0067]. The content-awareness application 110 shows f(x) satisfies the Lipschitz continuity with the Lipschitz constant L_{f} computed by using the following equation:

$${L}_{f} = \sqrt{4 {σ}_{max}^{2} ( μ {γ}_{2} {L}^{g} ) + 4 {σ}_{max}^{2} ( μ {γ}_{2} {L}^{u} ) + 6} .$$

The content-awareness application 110 iteratively solves for T and E by alternating between optimizing T and E. In an example, the content-awareness application 110 fixes E to Eₜ to solve Tₜ₊₁ based on the following equation:

$${T}_{t + 1} = {arg}_{T} min \frac{{L}_{f}}{2} {‖ T - {Y}_{t}^{T} + \frac{1}{{L}_{f}} {P}_{t}^{T} ‖}_{F}^{2} + μ {‖ T ‖}_{*} + μ {γ}_{1} {‖ {E}_{t} ‖}_{1} + f ( {Y}_{t} ) - \frac{1}{2 {L}_{f}} {‖ {P}_{t}^{T} ‖}_{F}^{2}$$

where Pₜ^{T}=μγ₂(Yₜ^{T}L^{u}+L^{g}Yₜ^{T})+Yₜ^{T}+Yₜ^{E}−M. This problem may be equivalent to the following equation:

$${T}_{t + 1} = arg {min}_{T} \frac{μ}{{L}_{f}} {‖ T ‖}_{*} + \frac{1}{2} {‖ T - {Y}_{t}^{T} + \frac{1}{{L}_{f}} {P}_{t}^{T} ‖}_{F}^{2} .$$

Based on the graph Laplacian equation, this problem may be further solved by a singular value threshold algorithm as follows:

$${T}_{t + 1} = U {\vert Σ \vert}_{\frac{μ}{{L}_{f}}} {V}^{T}$$

where UΣV^{T} represents a singular value decomposition (SVD) of

$${Y}_{t}^{T} - \frac{1}{{L}_{f}} {P}_{t}^{T} , {[ x ]}_{ɛ} .$$

This may be further defined as a soft-threshold operation as:

$${[ x ]}_{ɛ} = \{ \begin{matrix}x - ɛ & if x > ɛ \\ x + ɛ & if x < - ɛ \\ 0 & otherwise .\end{matrix}$$

Similarly, by fixing T, the content-awareness application 110 applies the above technique to compute a sparse error matrix E based on the following equation:

$${E}_{t + 1} = {[ {Y}_{t}^{E} - \frac{1}{{L}_{f}} ( {Y}_{t}^{T} + {Y}_{t}^{E} - M ) ]}_{\frac{μ {γ}_{1}}{{L}_{f}}} .$$

The summary of the details of the low-rank recovery algorithm may be shown as:

Low-Rank Recovery Algorithm Interest Group Refinement
Input: Initial interest group membership M ε R^{N}^{ᵤ}^{×N}^{_{g}} the graph Laplacian

L^{g} and L^{u}

Output: Refined membership matrix T ε R^{N}^{ᵤ}^{×N}^{_{g}} and error matrix E ε

R^{N}^{ᵤ}^{×N}^{_{g}}.

1: t = 0, T₀, T₋₁ = 0; E₀E₋₁ = 0; b₀b₋₁ = 1; μ̅ = δμ₀;
2: repeat
$3 \text{:} {Y}_{t}^{T} = {T}_{t} + \frac{{b}_{t - 1} - 1}{{b}_{t}} ( {T}_{t} - {T}_{t - 1} ) ;$
$4 \text{:} {Y}_{t}^{E} = {E}_{t} + \frac{{b}_{t - 1} - 1}{{b}_{t}} ( {E}_{t} - {E}_{t - 1} ) ;$
$5 \text{:} {P}_{t}^{T} = {Y}_{t}^{T} - \frac{1}{{L}_{f}} [ {μγ}_{2} ( {Y}_{t}^{T} {L}^{g} + {L}^{u} {Y}_{t}^{T} ) + {Y}_{t}^{T} + {Y}_{t}^{E} - M ] ;$
$6 \text{:} {T}_{t + 1} = {U [ Σ ]}_{\frac{{μ}_{t}}{{L}_{f}}} {V}^{T} , where ( U , Σ , V ) = sdv ( {P}_{t}^{T} ) ;$
$7 \text{:} {E}_{t + 1} = {[ {Y}_{t}^{E} - \frac{1}{{L}_{f}} ( {Y}_{1}^{T} + {Y}_{t}^{E} - M ) ]}_{\frac{{μ}_{t} {γ}_{1}}{{L}_{f}}} ;$
$8 \text{:} {b}_{t + 1} = \frac{1 + \sqrt{4 {b}_{t}^{2}}}{2} , {μ}_{t + 1} = max ( {ημ}_{t} , \overline{μ} ) ;$
9: t = t + 1;
10: until convergence.

where γ₁ and γ₂ represents parameters balancing a trade-off between sparse error and content consistency. In an example, γ₁ may be set to one and γ₂ may be set to four.

### Providing Recommendations for a Social Network

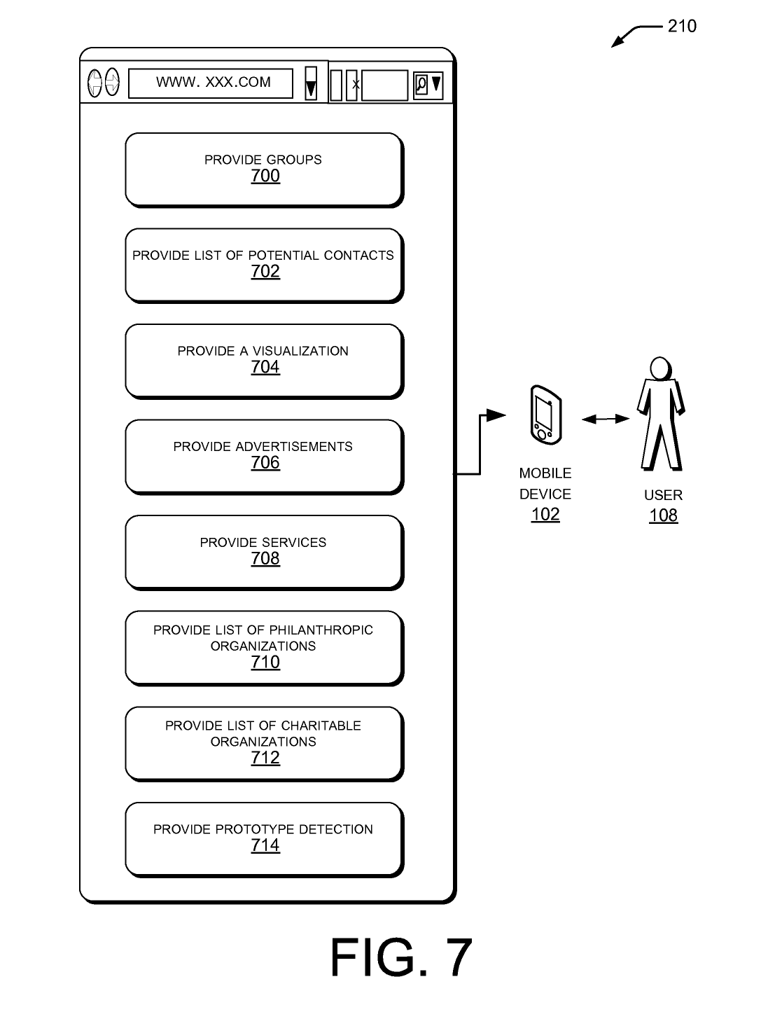

FIG. 7 illustrates an example phase 210 for providing recommendations, suggestions, and/or applications to the user based on the analysis of the user's interests and activities in the social network.

Although recommendations for groups 700 and suggestions for a list of potential contacts 702 may be provided to the user 108, other suggestions and/or applications may also be provided in the social network. In providing the suggestions for potential contacts 702, the content-awareness application 110 applies the equations as discussed with minor revisions for solving the optimization as:

min_{T,E}∥T∥_{*}+γ₁∥E∥₁+γ₂trT^{T}L^{u}T

s.t.N=T+E,Tε [symbol] ^{N}^{ᵤ}^{×N}ᵤ,Eε [symbol] ^{N}^{ᵤ}^{×N}^{ᵤ}

where Nε{0,1}^{N}^{ᵤ}^{×N}^{ᵤ}. The (i,j)-th entry of the N indicates whether uⱼ appears in the contact list of uᵢ. The potential contact matrix T becomes a square matrix reflecting the confidence whether the two users may be friends. This optimization may be solved by setting L⁹=0 using the low-rank recovery algorithm.

In addition, the content-awareness application 110 may provide a visualization 704 of the data based on discovering and understanding the community distribution between users and groups. The visualization 704 may include nodes with link structures to illustrate a specific user connected to other users. The content-awareness application 110 denotes T^{g} and T^{u} serve as solutions of T by applying the equations shown above. The content-awareness application 110 rearranges the columns and rows of T^{g} to form block structures and illustrates the clustering structure of interest groups by plotting a link graph between users according to T^{u}. The node with many edges tends to the most active member with the most links.

In other examples, the content-awareness application may provide a variety of suggestions and/or applications that include advertisements 706 directed towards the user 108, services 708, list of philanthropic organizations 710, or list of charitable organizations 712 of interest to the user 108, a prototype detection 714, and the like that are relevant based on the user's interests and activities in the social network. The prototype detection 714 is based on the visualization 704, where the distance between the nodes measures the similarity of the content uploaded by the users. A large node representing a user with many links plays a role in group formation and content propagation. The small nodes representing other users with few links play a small role in the described activities. While a node without any links may be viewed as an inactive user.

### Illustrative Server Implementation

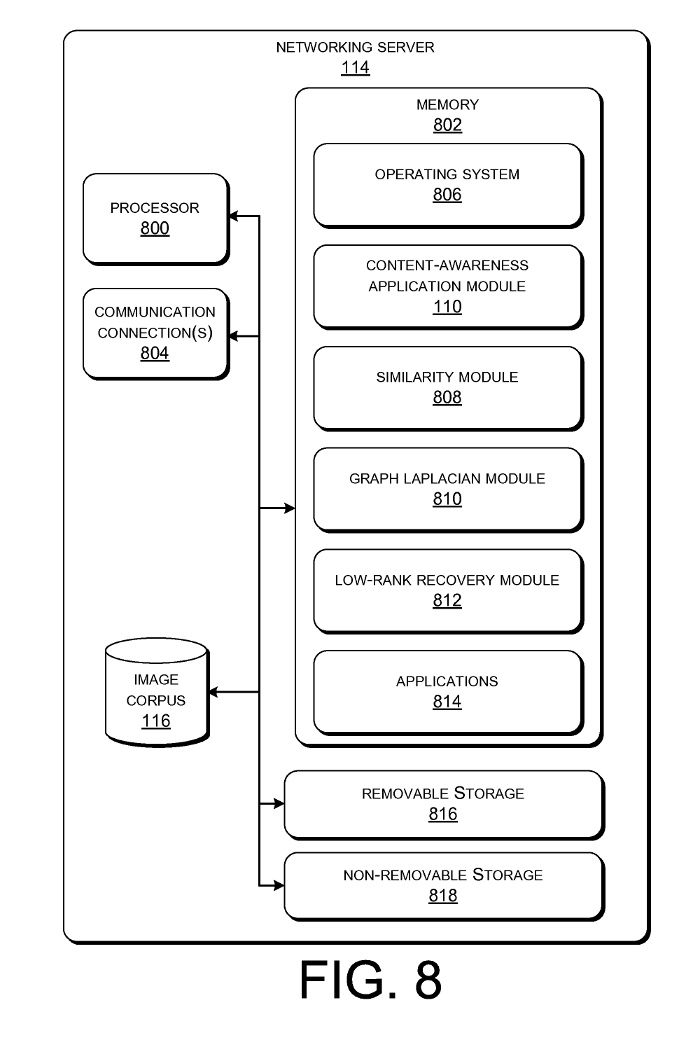

FIG. 8 is a block diagram showing an example networking server 114 usable with the environment of FIG. 1. The networking server 114 may be configured as any suitable system capable of services, which includes, but is not limited to, implementing the social-network service 106 for online services, such as accessing the content-awareness application 110 to provide images and information in response to the video clip submitted as the query. In one example configuration, the networking server 114 comprises at least one processor 800, a memory 802, and a communication connection(s) 804.

The processor(s) 800 may be implemented as appropriate in hardware, software, firmware, or combinations thereof. Software or firmware implementations of the processor(s) 800 may include computer-executable or machine-executable instructions written in any suitable programming language to perform the various functions described.

Memory 802 may store program instructions that are loadable and executable on the processor(s) 800, as well as data generated during the execution of these programs. Depending on the configuration and type of computing device, memory 802 may be volatile (such as random access memory (RAM)) and/or non-volatile (such as read-only memory (ROM), flash memory, etc.).

The communication connection(s) 804 may include access to a wide area network (WAN) module, a local area network module (e.g., WiFi), a personal area network module (e.g., Bluetooth), and/or any other suitable communication modules to allow the networking server 114 to communicate over the one or more networks 104.

Turning to the contents of the memory 802 in more detail, the memory 1002 may store an operating system 806, a module for the content-awareness application 110, a similarity module 808, a graph Laplacian module 810, a low-rank recovery module 812, and applications 814.

The social-network service 106 provides access to the content-awareness application module 110. The content-awareness application module 110 receives the images, performs analysis of the images, interacts with the other modules to provide assistance to create the representation of the user group and to create the model.

The content-awareness application module 110 further provides the display of the application on the user interface 112, extracting SIFT features from the images, and mining the information in the images along with the information from the social network.

The similarity module 808 calculates the similarity between the users and their images based on visual content of the images and the textual content based on their tags.

The graph Laplacian module 810 constructs the graph Laplacian over users and groups based on the similarity matrix. The graph Laplacian module 810 aligns the similarity matrix of visual content and the textual content to context. For example, the context may refer to the rich information available in the social network.

The low-rank recovery module 812 performs the optimization process using the accelerated gradient method as described and refines the groups and users for recommendations. The processes described above with references to FIGS. 1-7 may be performed by any of the modules or combination of the modules shown here. The networking server 114 may include the database 116 to store the collection of images, tags, annotations, descriptive words, SIFT features, data for the matrices, model, and the like. Alternatively, this information may be stored on a separate database.

The computing device or server may also include additional removable storage 816 and/or non-removable storage 818 including, but not limited to, magnetic storage, optical disks, and/or tape storage. The disk drives and their associated computer-readable media may provide non-volatile storage of computer readable instructions, data structures, program modules, and other data for the computing devices. In some implementations, the memory 802 may include multiple different types of memory, such as static random access memory (SRAM), dynamic random access memory (DRAM), or ROM.

Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The networking server 114 as described above may be implemented in various types of systems or networks. For example, the server 114 may be a part of, including but is not limited to, a client-server system, a peer-to-peer computer network, a distributed network, an enterprise architecture, a local area network, a wide area network, a virtual private network, a storage area network, and the like.

Various instructions, methods, techniques, applications, and modules described herein may be implemented as computer-executable instructions that are executable by one or more computers, servers, or mobile devices. Generally, program modules include routines, programs, objects, components, data structures, etc. for performing particular tasks or implementing particular abstract data types. These program modules and the like may be executed as native code or may be uploaded and executed, such as in a virtual machine or other just-in-time compilation execution environment. The functionality of the program modules may be combined or distributed as desired in various implementations. An implementation of these modules and techniques may be stored on or transmitted across some form of computer-readable media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A method implemented at least partially by a processor, the method comprising:
obtaining a collection of images and tags associated with the images belonging to members in a social network, the members represented as a members matrix;
decomposing the members matrix into a representative matrix;
identifying users and groups from the representative matrix to calculate a similarity matrix between the users and their images based on a visual content of the images and a textual content of the tags;
constructing a graph Laplacian over the users and the groups to align with the representative matrix based at least in part on the similarity matrix; and
providing recommendations of groups for a user to join in the social network based at least in part on the graph Laplacian identifying interests of the user.

2. The method of claim 1, wherein the visual content of the images further comprises:
extracting scale-invariant feature transform (SIFT) descriptors from the images;
assigning the SIFT descriptors to a nearest cluster;
measuring an image similarity of the images from the cluster; and
employing a centroid of the images to represent the visual content associated with the user.

3. The method of claim 1, wherein the textual content of the tags further comprises:
constructing a document with the tags being collected that correspond to the images;
computing a term frequency-inverse document frequency (tf-idf) weight for a tag; and
evaluating an importance of the tag to the document in the collection of tags.

4. The method of claim 1, wherein the similarity matrix further comprises:
measuring a similarity on the visual content between two images by a Gaussian kernel;
measuring a first similarity between two users based on the visual content;
classifying the textual content of the tags by adopting a normalized linear kernel; and
measuring a second similarity between two users based on the textual content.

5. The method of claim 1, further comprising:
recovering a low-rank matrix from the members as the representative matrix; and
refining the low-rank matrix based on an accelerated proximal gradient method.

6. The method of claim 1, further comprising representing the textual content of the tags by:
adopting a bag-of-words model in processing the tags; and
building a dictionary by correlating the tags with the bag-of-words model.

7. The method of claim 1, further comprising:
identifying a user-user contact relationship to be analyzed;
creating a potential contact matrix to reflect a confidence that the users and an individual user are friends; and
providing suggestions of potential contacts to the user in the social network based on a ranked list of contacts of the users.

8. The method of claim 1, further comprising providing advertisements based on the interests of the user.

9. One or more computer-readable storage media encoded with instructions that, when executed by a processor, perform acts comprising:
creating a membership matrix from an online community, the membership matrix to be decomposed into a low-rank matrix of users uploading images and tags associated with the images;
minimizing distortions among group-user relationships by computing a similarity matrix based on the users from the low-rank matrix and the uploaded images;
encoding a graph Laplacian over group assignments and of the users based on the similarity matrix; and
refining the low-rank matrix in response to the graph Laplacian by using an accelerated proximal gradient method.

10. The computer-readable storage media of claim 9, wherein the images uploaded by the users comprise:
extracting scale-invariant feature transform (SIFT) descriptors from the images to be assigned to a nearest cluster;
measuring an image similarity of the images from the cluster; and
filtering out noisy SIFT descriptors by employing a centroid of the images to represent a visual content of the image associated with a user.

11. The computer-readable storage media of claim 9, wherein the similarity matrix comprises:
measuring a visual content of the images based on calculating a similarity between two images by a Gaussian kernel and calculating a similarity between two users based on their images; and
measuring a textual content of the images based on classifying a textual content of the tags by adopting a normalized linear kernel.

12. The computer-readable storage media of claim 9, wherein the similarity matrix comprises:
constructing a document with tags that correspond to the images;
computing a term frequency-inverse document frequency (tf-idfi weight for a tag; and
evaluating an importance of the tag to the document in a collection of the tags.

13. The computer-readable storage media of claim 9, further comprising enforcing content consistency by aligning the low-rank matrix with the graph Laplacian to rectify the group assignments.

14. The computer-readable storage media of claim 9, further comprising creating a group matrix to reflect a confidence that a user belongs to the group assignments.

15. The computer-readable storage media of claim 9, further comprising providing recommendations of groups in a rank-order list based on the interests of a user.

16. The computer-readable storage media of claim 9, further comprising:
creating a potential contact matrix to reflect a confidence that the users and a user share common interests; and
providing suggestions of potential contacts in the social network based on the shared common interests of the users and the user.

17. A system comprising:
a memory;
a processor coupled to the memory;
a social application module operated by the processor and configured to construct a representation of users and groups on a social network and to retrieve images and tags associated with the images uploaded by the representation of the users on the social network; and
a similarity module operated by the processor and configured to compute a similarity matrix between the users based on similarities of visual content of the images and textual content of the tags.

18. The system of claim 17, wherein the similarity matrix between the users is based at least in part on:
measuring the visual content of the images based on calculating a similarity between two images by a Gaussian kernel and calculating a similarity between two users based on their images; and
measuring the textual content of the tags based on adopting a normalized linear kernel to classify the textual content.

19. The system of claim 17, further comprising:
a graph Laplacian module operated by the processor and configured to encode a geometry of group assignments and of the users; and
a content-awareness module operated by the processor and configured to refine the representation of the users in response to the graph Laplacian by using an accelerated proximal gradient method.

20. The system of claim 17, the content-awareness module operated by the processor and configured to:
refine the groups from the representation of users based on using an accelerated proximal gradient method; and
provide recommendations of the groups based on the user's similarities to other users in the groups.
